(19) United States
(12) Patent Application Publication
(10) Pub. No.: US 2007/0093218 A1
(43) Pub. Date: Apr. 26, 2007

(54) Rf circuit arrangement for modulation of an rf carrier signal

(76) Inventor: Jorg Nagel, Krefeld (DE)

Correspondence Address: BELL, BOYD & LLOYD, LLP, P.O. BOX 1135, CHICAGO, IL, 60690, US

(21) Appl. No.: 10/555,942

(22) PCT Filed: Apr. 13, 2004
(86) PCT No.: PCT/EP04/03882

§ 371 Date: Nov. 7, 2005

(30) Foreign Application Priority Data
May 6, 2003 (DE) 10320177.7

(51) Int. Cl. H04B 1/04; H01Q 11/12

(52) U.S. Cl. 455/114.3; 455/126

(57) ABSTRACT

An HF circuit arrangement is provided for amplitude and phase modulation of an HF carrier signal, including an oscillator for providing the HF carrier signal, an amplifier for amplifying the HF signal emitted by the oscillator, a phase control circuit for suppressing phase errors in an output signal of the amplifier, an amplitude control circuit for suppressing amplitude errors in the output signal of the amplifier, and a signal decoupling unit for decoupling the output signal of the amplifier for the amplitude control circuit and the phase control circuit. The present invention seeks to improve modulation quality and to reduce nose sidebands. For this purpose, a bandwidth of a control circuit can be adjusted via a bandwidth adjusting device. Such bandwidth adjusting device is provided with a characteristic curve which includes an allocation between the bandwidth of the control circuit and measured values for a parameter on which the bandwidth of the control circuit depends.

### BACKGROUND

The present invention relates to an RF circuit arrangement for amplitude and phase modulation of an RF carrier signal, having an oscillator for production of the RF carrier signal, a power amplifier for amplification of the RF signal coming from the oscillator, a phase locked loop for suppression of phase errors in an output signal from the power amplifier, an amplitude control loop for suppression of amplitude errors in the output signal from the power amplifier, and a directional coupler for outputting the output signal from the power amplifier for the amplitude control loop and the phase locked loop.

The RF circuit arrangement is used for radio-frequency signal production and amplification; for example, in mobile radio terminals to the GSM EDGE Standard or to other mobile radio standards.

The output signal from the power amplifier in RF circuit arrangements such as these has to satisfy minimum quality requirements. Both amplitude control and phase control are used for RF circuit arrangements such as these for this purpose, in order to take account of signal distortion which can occur as a result of non-linear effects of the electronic components which are used in the RF circuit arrangement. Furthermore, components such as these frequently contain noise sources which add broadband noise signals to the radio-frequency output signal which is produced by the power amplifier. In particular, these noise signals also may be outside the useful signal bandwidth of the power amplifier.

Thus, it can be stated that two important criteria must be satisfied for the quality of the output signal from the power amplifier. The modulation of a useful signal onto the RF carrier signal must satisfy a required signal accuracy. Furthermore, the output signal from the power amplifier must, as far as possible, have parasitic secondary signals outside the useful signal bandwidth removed from it.

Phase locked loops and amplitude control loops are used for these purposes in the prior art. The use of these control loops and phase locked loops has the advantage that they suppress any errors such as the non-linearities and offsets mentioned above within their respective control bandwidth. The removal of these errors becomes better as the bandwidths of the control loops and phase locked loops become wider.

One disadvantage of this known solution, however, is that the control loops and phase locked loops emit additional noise signals outside their respective control bandwidth, which produce noise sidebands at a greater frequency interval from the RF carrier signal, and these reduce the quality of the output signal from the power amplifier. The control loops and phase locked loops may be provided with narrow control bandwidths in order to avoid noise sidebands.

To this extent, the two requirements for high modulation quality, on the one hand, and small noise sidebands caused by the control loops and phase locked loops, on the other hand, are contradictory, so that a compromise must be chosen, at the expense of one or both characteristics.

Against this background, the present invention is directed toward further developing the RF circuit arrangement mentioned initially in such a way as to better satisfy the two requirements for height modulation quality and small noise sidebands.

### SUMMARY

In the case of the RF circuit arrangement mentioned initially, this is achieved in that the bandwidth of the control loop or phase locked loop can be adjusted via a bandwidth adjusting device, and the bandwidth adjusting device has a characteristic which includes an association between the bandwidths of the control loop or phase locked loop and measured values for a parameter on which the bandwidth of the control loop or phase locked loop is dependent. The characteristic may be provided, for example, by a table or an analog circuit.

According to the present invention, the bandwidth of at least one of the control loops or phase locked loops is adjustable. This has the advantage that as much bandwidth is available for the amplitude or phase control that is carried out as is required for the error at that time. This effectively suppresses the noise sidebands which occur and are caused by the control loop or phase locked loop.

The bandwidth of the control loop or phase locked loop is adjusted by using the bandwidth adjusting device to store a relationship between the bandwidth of the control loop or phase locked loop and measured values for a parameter on which the bandwidth of the control loop or phase locked loop depends. A search for suitable parameters which can be used for bandwidth adjustment can be carried out in this relationship for various modulation types, such as 80 PSK in accordance with the GSM EDGE Standard.

By way of example, it is possible to use a procedure in which a dependency of the bandwidth of the control loop or phase locked loop whose bandwidth can be adjusted is measured empirically for two or more possible parameters, on the basis of which the most suitable parameter is chosen for use by the bandwidth adjusting device. Those parameters on which the bandwidth of the relevant control loop or phase locked loop is highly dependent are particularly suitable. The parameters which are, in each case, desirable may depend on the respectively used modulation method.

Empirical investigations by the inventor have shown that it is advantageous for 80 PSK modulation for the control loop or phase locked loop whose bandwidth is adjustable via the bandwidth adjusting device to be the phase locked loop and the parameter to be a nominal amplitude for the amplitude control loop. However, other parameters also are feasible, such as the actual amplitude of the amplitude control loop.

The bandwidth adjusting device also may be designed to adjust the bandwidths of the phase locked loop and of the amplitude control loop. This has the advantage that this allows time-synchronous modulation of the amplitude and phase during all modulation states.

The choice of the parameters whose relationship with the control loop or phase locked loop bandwidths is used for bandwidth adjustment makes it possible to determine whether any change would, in fact, result in an improvement of the signal accuracy of the modulation or, instead, in a reduction in the noise sidebands.

It should be stressed that even the measure of operating only one of the control loops or phase locked loops with an adjustable bandwidth results in an improvement over the prior art in that a reduction in the noise sidebands is achieved for the same signal accuracy for modulation of the useful signal. The fundamental improvement in the ratio of the noise sidebands and signal quality which results therefrom also may be used to produce the RF circuit arrangement with lower-cost components but with the technical performance being unchanged, in comparison to the prior art.

Additional features and advantages of the present invention are described in, and will be apparent from, the following Detailed Description of the Invention and the Figures.

### BRIEF DESCRIPTION OF THE FIGURES

FIG. 1 shows a block diagram of an RF circuit arrangement having an amplitude control loop and a phase locked loop.

FIG. 2 shows an illustration, in the form of a graph, of the relationship between the amplitude of GSM EDGE 80 PSK modulation and time.

FIG. 3 shows an illustration, in the form of a graph, of the relationship between a phase of a GSM 80 PSK modulated signal and time, with the time axis matching that in FIG. 2.

FIG. 4 shows an RF circuit arrangement having an amplitude control loop and a phase locked loop according to the prior art.

### DETAILED DESCRIPTION

In order to describe the present invention, in particular its differences from the prior art, an RF circuit arrangement having an amplitude control loop and a phase locked loop according to the prior art as are shown in FIG. 4 first of all will be explained.

A nominal phase signal φₛ and an nominal amplitude signal Aₛ are used as the input signals for the RF circuit arrangement. The nominal phase signal φₛ is applied to a first input of a phase comparator PK. An output signal from the phase comparator PK passes through a low-pass filter LPF1 which, by way of example, is in the form of an arrangement based on an integrator (loop filter). An output signal from the low-pass filter LPF1 is passed to a local oscillator VCO. A phase-modulated input signal for a power amplifier Amp is produced at one output of the local oscillator VCO.

The nominal amplitude signal Aₛ is applied to a first input of an amplitude comparator AK. An output signal from the amplitude comparator AK passes through a second low-pass filter LPF2. The low-pass filter LPF2 is, for example, in the form of an arrangement based on one or two integrators (loop filters). An output signal from the low-pass filter LPF2 is passed to the power amplifier Amp, in which amplitude modulation and signal amplification are carried out.

An output signal from the power amplifier Amp is used further in a transmission path RF, at whose end an antenna is provided.

The RF circuit arrangement also includes as a signal output unit a directional coupler RK, to whose input the output signal from the power amplifier Amp is applied. A part of this output signal, which is both amplitude-modulated and phase-modulated, is tapped off via the directional coupler RK, and is fed back. On a feedback path, the signal which has been tapped off by the directional coupler is passed to an amplitude and phase determination device APB, with whose aid an amplitude signal Aᵢ from the signal which has been tapped off from the directional coupler is sent to the second input of the amplitude comparator AK. An actual phase signal φᵢ coming from the amplitude and phase determination device is passed to the second input of the phase comparator PK.

In an RF circuit arrangement such as this, according to the prior art, the bandwidths of the two low-pass filters LPF1 and LPF2 are fixed.

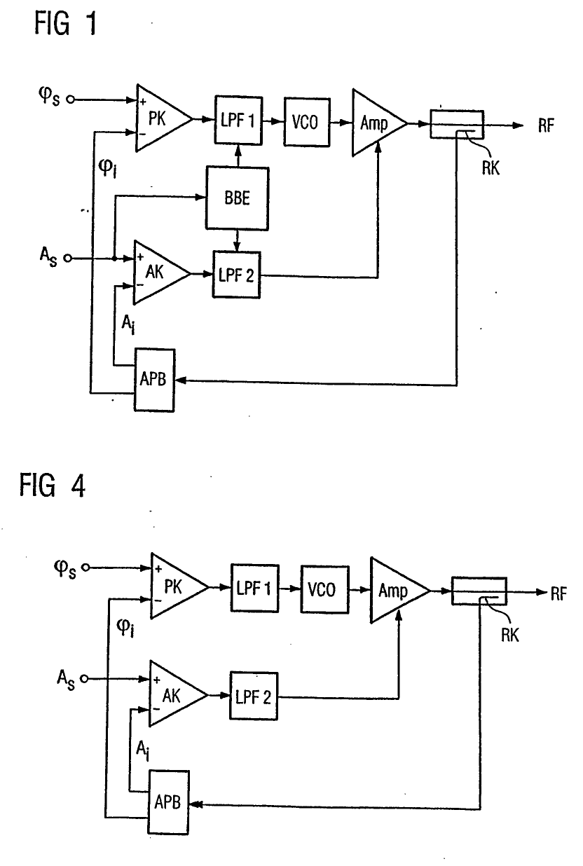

One exemplary embodiment of the present invention now will be explained with reference to FIG. 1, on the basis of the RF circuit arrangement shown in FIG. 4. In this case, components which are functionally similar to the components in the RF circuit arrangement shown in FIG. 4 are annotated with the same reference symbols as in FIG. 1.

Comparison of FIGS. 1 and 4 shows that a bandwidth adjusting device BBE is provided as an additional device in FIG. 1 and is connected to the two low-pass filters LPF1 and LPF2, whose frequency characteristics are adjustable (filter coefficient set). Aₛ its input signal, the bandwidth adjusting device BBE receives the nominal amplitude signal Aₛ. In the present exemplary embodiment, the bandwidth adjusting device BBE controls both the bandwidth of the low-pass filter LPF1, which is part of the phase locked loop, and the bandwidth of the low-pass filter LPF2, which is part of the amplitude control loop, as a function of an instantaneous value of the nominal amplitude signal Aₛ. For this purpose, a characteristic is stored in the bandwidth adjusting device BBE, containing associations between values for the nominal amplitude signal Aₛ and values for the bandwidths (filter coefficients) of the two low-pass filters LPF1 and LPF2. In the case of a simplified embodiment, the bandwidth adjusting device BBE also may be connected exclusively to the low-pass filter LPF1 in the phase locked loop, so that no bandwidth adjustment is carried out for the amplitude control loop. In this case, the reference table contains only entries for the bandwidth of the low-pass filter LPF1 and the nominal amplitude signals Aₛ.

If both the bandwidth of the low-pass filter LPF1 and the bandwidth of the low-pass filter LPF2 are controlled, the respective bandwidth values may match, thus allowing time-synchronous modulation of the amplitude and phase during all modulation states. Alternatively, the bandwidths also may be adjusted independently of one another in order to minimize distortion in the amplitude modulation and phase modulation.

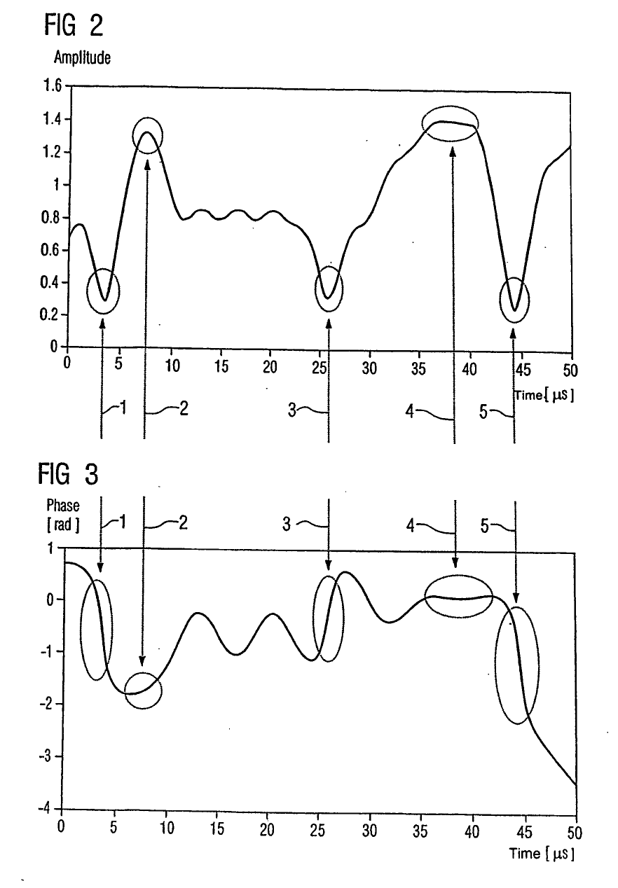

A relationship between an instantaneously required bandwidth for the phase locked loop and values for the nominal amplitude signal Aₛ now will be described, with reference to FIGS. 2 and 3, for a modulation method for an 80PSK signal based on the GSM EDGE Standard. In this modulation method, the bandwidths of the low-pass filters LPF1 and LPF2 are typically in the range from 1 to 10 MHz, thus defining their adjustment range.

FIG. 2 shows the waveform of the nominal amplitude signal Aₛ, while FIG. 3 shows a waveform of the nominal phase signal φₛ.

For illustrative purposes, FIGS. 2 and 3 each show mutually corresponding areas on both the time/amplitude plane and the time/phase plane. These areas are annotated with the reference numbers 1, 2, 3, 4 and 5.

Detailed analysis shows that rapid phase changes take place when the instantaneous nominal amplitude signals Aₛ are small, while phase changes take place more slowly when the instantaneous nominal amplitude signals Aₛ are large. It can be seen from this that the bandwidth of the low-pass LPF1 for the phase locked loop must be chosen to be higher when the instantaneous nominal amplitude signal Aₛ is small than when the instantaneous nominal amplitude signals Aₛ are large.

By way of example, the values of the nominal amplitude signal Aₛ are small in the areas 1, 3 and 5, which leads to an increase in the required bandwidth of the low-pass filter LPF1. In contrast, the value of the nominal amplitude signal Aₛ in each of the areas 2, 4 is high, which leads to a narrower bandwidth requirement for the low-pass filter LPF1. To this extent, it is possible to vary the instantaneous bandwidth of the phase locked loop or of both the amplitude control loop and the phase locked loop as a function of the profile of the nominal amplitude signal Aₛ, so that the required bandwidth for processing of the phase modulation and, possibly, also of the amplitude modulation is always available, but with excess bandwidth being reduced. Noise sidebands outside the useful signal bandwidth are, thus, effectively suppressed.

Although the present invention has been described with reference to specific embodiments, those of skill in the art will recognize that changes may be made thereto without departing from the spirit and scope of the present invention as set forth in the hereafter appended claims.

1-4. (canceled)

5. An RF circuit arrangement for amplitude and phase modulation of an RF carrier signal, comprising:
an oscillator for producing the RF carrier signal;
a power amplifier for amplifying the RF signal coming from the oscillator;
a phase locked loop for suppressing phase errors in an output signal from the power amplifier;
an amplitude control loop for suppressing amplitude errors in the output signal from the power amplifier;
a signal output unit for outputting the output signal from the power amplifier for the amplitude control loop and the phase locked loop; and
a bandwidth adjusting device for adjusting a respective bandwidth of the amplitude control loop and the phase locked loop, wherein the bandwidth adjusting device has a characteristic which includes an association between the bandwidths of the amplitude control loop and the phase locked loop and measured values for a parameter on which the respective bandwidth of the amplitude control loop and the phase locked loop is dependent.

6. An RF circuit arrangement as claimed in claim 5, wherein the amplitude control loop, the phase locked loop and the parameter is a nominal amplitude for the amplitude control loop.

7. An RF circuit arrangement as claimed in claim 5, further comprising first and second low-pass filters, wherein the bandwidth of the phase locked loop is defined by the first low-pass filter and the bandwidth of the amplitude control loop is defined by the second low-pass filter, and wherein frequency characteristics of the first and second low-pass filters respectively associated with the amplitude control loop and the phase locked loop are adjustable and connected to the bandwidth adjusting device.
